(19) United States
(12) Patent Application Publication
(10) Pub. No.: US 2018/0259551 A1
(43) Pub. Date: Sep. 13, 2018

(54) Fiber-Optic Accelerometer

(71) Applicant: Siemens Aktiengesellschaft, München (DE)

(72) Inventor: Michael Villnow, Fuerth (DE)

(73) Assignee: Siemens Aktiengesellschaft, Muenchen (DE)

(21) Appl. No.: 15/758,422

(22) PCT Filed: Sep. 6, 2016
(86) PCT No.: PCT/EP2016/070950

§ 371 Date: Mar. 8, 2018

(30) Foreign Application Priority Data
Sep. 11, 2015 (DE) 10 2015 217 430.1

(51) Int. Cl. G01P 15/093; G01D 5/26

(52) U.S. Cl. CPC G01P 15/093; G01D 5/268

(57) ABSTRACT

The present disclosure relates to generators. Various embodiments thereof may include a fiber-optic accelerometer, in particular for use in a generator. For example, a fiber-optic accelerometer may include: an optical fiber having a free end, wherein the free end can be caused to vibrate under the influence of acceleration; a light source for emitting visible, ultraviolet, or infrared light into the optical fiber; a mirror arranged to reflect a portion of the light exiting the free end back into the optical fiber; and a detection device sensing reflected light at the end of the fiber opposite from the free end. The core of the optical fiber may include a Bragg grating in the free end.

### CROSS-REFERENCE TO RELATED APPLICATIONS

This application is a U.S. National Stage Application of International Application No. PCT/EP2016/070950 filed Sep. 6, 2016, which designates the United States of America, and claims priority to DE Application No. 10 2015 217 430.1 filed Sep. 11, 2015, the contents of which are hereby incorporated by reference in their entirety.

### TECHNICAL FIELD

The present disclosure relates to generators. Various embodiments thereof may include a fiber-optic accelerometer, in particular for use in a generator.

### BACKGROUND

Generators used in power plants have, among others, vibrations at twice the mains frequency in the region of the end winding. If the amplitudes of the bar vibrations are too high, the insulation or the copper can become damaged. Since the end winding is at a high voltage potential, such damage may have serious consequences. Fiber-optic accelerometers (FOA) are increasingly used to monitor such vibrations.

The accelerometer known from DE 10 2010 019 813 A1 converts the deflection of a free end of an optical fiber to an intensity change of a light signal by directing the free end of the fiber onto a tilted mirror. In this sensor principle, the resonance frequency of the sensor is defined by the modulus of elasticity, the geometrical moment of inertia, the density, and the length of the free fiber. The sensitivity of the sensor corresponds to the deflection at the fiber end and is described by the same parameters. External influences, such as the temperature, change the accuracy of the signal.

### SUMMARY

The teachings of the present disclosure may enable a fiber-optic accelerometer in which the influence of the temperature of the sensor on the accuracy of the signal is reduced. For example, in some embodiments a fiber-optic accelerometer (10) may include: an optical fiber (11, 35, 50) having a free end, wherein the free end can be caused to vibrate under the influence of acceleration, a light source for emitting visible, ultraviolet or infrared light into the optical fiber (11, 35, 50) at an end of the fiber (11, 35, 50) that is remote from the free end, a mirror (14) arranged to reflect a portion of the light exiting the free end into the optical fiber (11, 35, 50), and a detection device for receiving reflected light at the end of the fiber (11, 35, 50) that is remote from the free end, characterized in that the core (30, 53, 54, 101) of the optical fiber (11, 35, 50) contains a Bragg grating (105) in the free end.

In some embodiments, the detection device is configured for evaluating a reflection signal of the Bragg grating (105).

In some embodiments, the optical fiber (11, 35, 50) is configured as a single-mode waveguide.

In some embodiments, the optical fiber (11, 35, 50) is a double-cladding fiber (35, 50) having a core (30, 53, 54, 101), an internal cladding (31, 52) and an external cladding (32, 51).

In some embodiments, the numerical aperture of the core (30, 53, 54, 101) ranges from 0.075 to 0.14, and the numerical aperture of the internal cladding (31, 52) ranges from 0.22 to 0.5.

In some embodiments, there is a single-mode core (53), in which the Bragg grating (105) is arranged, and at least one multi-mode core (54).

In some embodiments, the length of the free end is between 12 and 18 mm, in particular between 15 and 17 mm.

In some embodiments, the termination surface of the free end is formed by a fraction of the optical fiber (11, 35, 50) that is at an angle of between 5° and 18°, in particular between 12° and 18°, with respect to the plane that is perpendicular to the fiber axis.

In some embodiments, the tilting axes of the fracture of the optical fiber (11, 35, 50) and of the mirror (14) with respect to the plane perpendicular to the fiber axis are oriented to be parallel with respect to one another.

In some embodiments, the distance between the fiber termination surface and the mirror (14) is between 25 μm and 75 μm.

In some embodiments, only the own weight of the optical fiber (11, 35, 50) is used as oscillating weight.

As another example, some embodiments may include an electrical machine, in particular a generator, having at least one fiber-optic accelerometer (10) as described above.

### BRIEF DESCRIPTION OF THE DRAWINGS

Some exemplary embodiments which are not restrictive in any way will now be explained in more detail with reference to the figures of the drawing. Here, the features are illustrated in schematic fashion and not necessarily to scale. In the figures,

FIG. 1 shows a fiber-optic accelerometer having a glass fiber and a mirror according to teachings of the present disclosure;

FIG. 2 shows a section of the fiber-optic accelerometer in an enlarged illustration according to teachings of the present disclosure;

FIG. 3 shows a longitudinal section through a glass fiber according to teachings of the present disclosure;

FIG. 4 shows a longitudinal section through a double-cladding fiber according to teachings of the present disclosure;

FIG. 5 shows a cross section through a multicore fiber according to teachings of the present disclosure.

### DETAILED DESCRIPTION

In some embodiments, a fiber-optic accelerometer comprises an optical fiber having a free end, wherein the free end is caused to vibrate under the influence of acceleration, and said vibrations are detected as a measure of the acceleration. It furthermore comprises a light source for emitting visible, ultraviolet or infrared light into the optical fiber at an end of the fiber that is remote from the free end, a mirror arranged to reflect a portion of the light exiting the free end into the optical fiber, and a detection device for receiving reflected light at the end of the fiber that is remote from the free end. According to the invention, the core of the optical fiber contains a Bragg grating in the free end.

The temperature of the optical fiber can be measured using a Bragg grating inscribed near the end of the optical fiber into the core thereof. As a result, no additional sensor must be mechanically mounted here. Furthermore, the measured temperature as far as possible corresponds to the actual sensor temperature, which also influences the measurement signal for the acceleration. Finally, the Bragg grating with its optical evaluation may be immune against electrical influences and causes no electrical disturbances toward the outside either.

In some embodiments, the detection device evaluates a reflection signal of the Bragg grating. The light which is already introduced for detecting the acceleration is also used, or a separate light signal may be supplied. Spectral evaluation of the reflection of the Bragg grating then gives the temperature of the optical fiber at the location of the Bragg grating.

In some embodiments, the optical fiber comprises a single-mode waveguide. This permits simplified evaluation of the temperature from the reflection signal of the Bragg grating. The optical fiber may comprise as a multi-mode waveguide. In that case, the signal quality with respect to the acceleration measurement may be better than a single-mode waveguide.

In some embodiments, the optical fiber may comprise a multicore fiber having a single-mode core and at least one multimode core. The single-mode core having a diameter of for example 9 μm comprises the Bragg grating and serves for querying the temperature. The multi-mode core or cores serve for guiding radiation to the free end of the optical fiber for the acceleration measurement.

In some embodiments, the optical fiber may comprise a double-cladding fiber having one or more cores, an internal cladding, and an external cladding. In this case, the numerical aperture of the internal cladding may be greater than that of the core or the cores which serve/serves for guiding the radiation for the acceleration measurement. This ensures that a larger portion of the radiation that is reflected by the mirror can be captured for the return direction of the optical fiber and thus an improved signal is obtainable, because the light reflected at the mirror is incident on the fiber end surface and can also be coupled in and guided here by the internal cladding with a greater numerical aperture at significantly greater angles than with a simple optical fiber. In particular, the mirror can be tilted at a greater angle with a predetermined output loss, which ensures a stronger acceleration signal.

In some embodiments, a range for the numerical aperture of the core or of the cores for guiding the radiation for the acceleration measurement is 0.075 to 0.14. In some embodiments, a range for the numerical aperture of the internal cladding is 0.22 to 0.5. The internal cladding may comprise a multi-mode waveguide.

The Bragg grating may be arranged near the free end of the optical fiber, for example within the 25% of the optical fiber closest to the fiber termination of the free end of the fiber.

Values for the multi-mode core or cores of the optical fiber can be, for example, 50 μm or 62.5 μm as a multi-mode core, or for example 25 μm as an intermediate value, so-called few mode. The internal cladding as multi-mode core can have both standard values such as 62.5 μm for the case of an individual single-mode core and greater diameters such as for example 200 μm or 400 μm.

In some embodiments, to keep the resonance frequency sufficiently high with respect to the operating frequency, typically 400 Hz, the length of the fiber may be relatively small. However, for a high sensitivity, a large fiber length may be used. In some embodiments, a fiber length of between 12 and 18 mm is used for the free end for a standard multimode fiber 62/125 μm. In particular embodiments, there is a fiber length of between 15 and 17 mm. A fiber length of 16 mm may provide a reasonable balance with respect to the resonance frequency and sensitivity.

In some embodiments, only the weight of the optical fiber is used as the oscillating weight.

In some embodiments, to prevent back reflections at the termination surface of the optical fiber, an 8° fracture of the end surface is used. The azimuthal orientation of the fiber end relative to the mirror may be chosen such that the fracture and the mirror surface enclose the maximum angle possible. In other words, fracture and mirror surface form the shape of a “V.” Due to the oblique termination surface, the light is refracted slightly downwardly from the fiber—downwardly with respect to the shape of the “V”—by approximately 3.5°. As a result, the effective angle of incidence on the mirror is reduced.

In some embodiments, the mirror is tilted by an angle between 9° and 13°. The azimuthal orientation of the fiber end relative to the mirror may be chosen such that the fracture and the mirror surface enclose the maximum angle possible. In other words, fracture and mirror surface form the shape of a “V.” In particular, the mirror is tilted by 11°.

In some embodiments, the mirror and fiber end can also be arranged relative to one another such that the enclosed angle is minimized. In other words, the oblique mirror surface and the fracture form an arrangement in the manner of a parallelogram.

In some embodiments, the distance between the glass fiber and the mirror is between 25 and 75 μm. The described configuration may provide a relatively linear sensor characteristic line between acceleration values of 0 and 10 g with a sensitivity of approximately 1%/g.

To simplify the setup, all elements of the sensor head may have a cylinder-symmetric configuration. The cylindrical sensor is then inserted into a rectangular block. The supply line is, for example, a Teflon tube of 3-5 mm diameter, in which the glass fiber is loosely laid. At the end of the supply line is a plug for optical waveguides, for example of type FC-APC or E-2000.

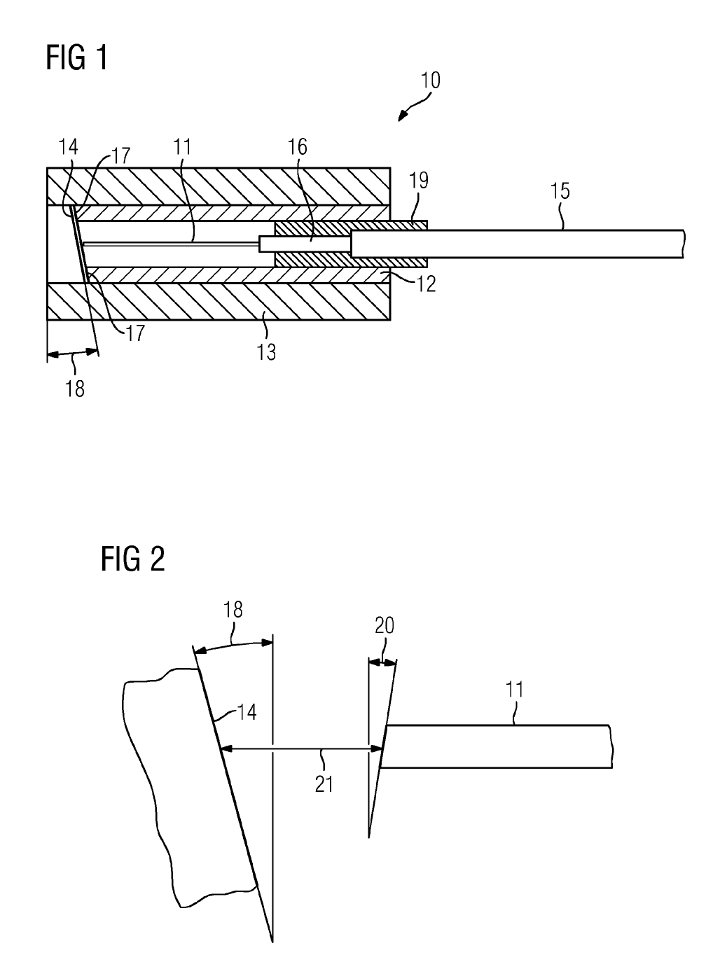

The fiber-optic accelerometer 10 shown in FIG. 1 comprises a glass fiber 11 comprising a double-cladding fiber. A section of the glass fiber 11 of 16 mm length is free-standing. The glass fiber 11 terminates at the end of said section. Adjoining the free-standing section, the glass fiber 11 is fixed in a guide element 16. In some embodiments, the glass fiber 11 is loosely guided in a Teflon tube 15 having a 3.7 mm diameter.

The end of the Teflon tube 15 is enclosed, together with the guide element 16, by a first sleeve 19. A second sleeve 12 is provided around the first sleeve 19. The second sleeve 12 extends from the region of the first sleeve over the free section of the glass fiber 11. At the end face where the glass fiber 11 terminates, the second sleeve 12 has a termination that is chamfered at an angle of 11° and manifests in the cylindrical second sleeve 12 in a circular, chamfered end 17. The second sleeve 12 itself is open at this location and is terminated by an Al glass mirror 14. The Al glass mirror 14 is secured on the chamfered end by way of adhesive bonding, such that the Al glass mirror 14 itself is mounted at an angle with respect to the normal plane of the fiber axis.

A cuboid element 13 encloses the setup as described above from the height of the Al glass mirror 14 to the first sleeve 19. The free section of the glass fiber 11 is completely isolated from the outside by the sleeves 19, 12 and the cuboid element 13 and the Al glass mirror 14 and the guide element 16, with the result that no disturbing influences act from outside on a measurement. In some embodiments, the cuboid element 13 and the sleeve 12 can also be fused to form a single component.

FIG. 2 shows an enlarged illustration, which is not to scale, of the end of the glass fiber 11 in relation to the Al glass mirror 14. Light radiated into the glass fiber 11 exits the latter into a free beam section. The light is reflected at the Al glass mirror 14, and some of the light once again enters the glass fiber 11.

The Al glass mirror 14, which in the enlargement shown in FIG. 2 is no longer shown in its entirety, is arranged at an angle 18 of 11° with respect to the normal plane of the glass fiber axis. The distance 21 between the end of the glass fiber 11 and the Al glass mirror 14 in this example is 50 μm.

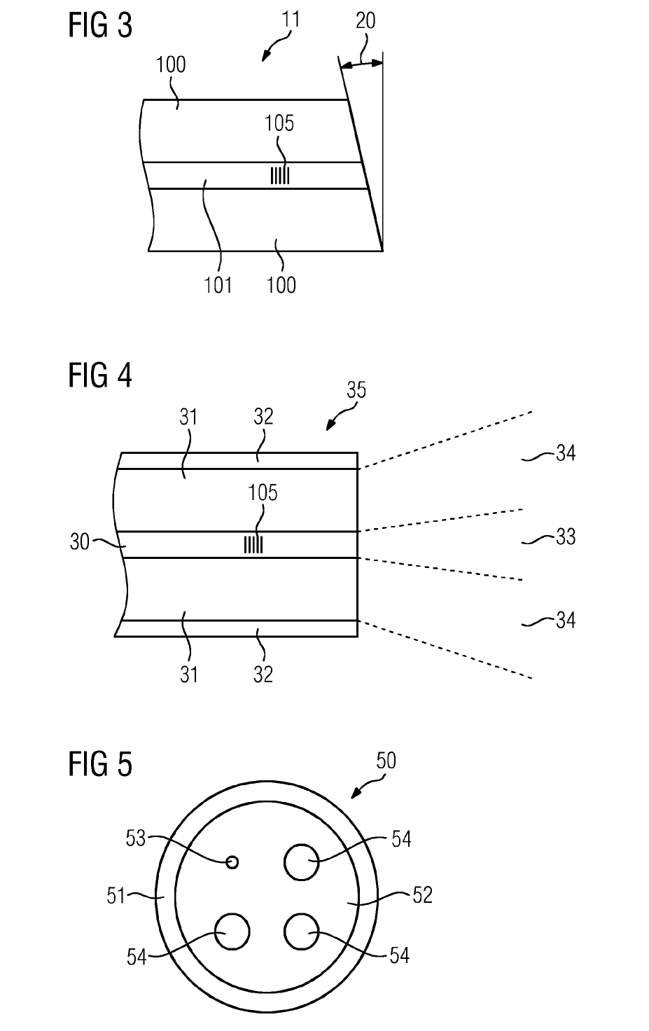

FIG. 3 shows a longitudinal section through the glass fiber 11. The glass fiber 11 comprises a cladding 100 and a single-mode core 101. FIG. 3 once again shows that the glass fiber 11 ends at an angle 20 with respect to the perpendicular. Near the end of the glass fiber 11, the Bragg grating 105 is inscribed in the single-mode core 101. The distance from the end of the glass fiber 11 is here not illustrated to scale.

Requesting the temperature of the glass fiber 11 takes place by injecting radiation with components in the range of the reflection wavelength of the Bragg grating 105 into the glass fiber 11 and capturing reflected radiation. The reflected radiation here shows a performance peak at the reflection wavelength of the Bragg grating 105, with the reflection wavelength of the Bragg grating 105 depending on the temperature of the glass fiber 11.

The radiation used can be the same radiation used for the measurement of the acceleration. In some embodiments, a separate radiation source can be used, which injects radiation into the glass fiber 11 specifically for the measurement of the temperature.

The glass fiber 11 can also be replaced by other configurations of optical fibers. One example of a further configuration of the optical fiber is shown in FIG. 4. The optical fiber 40 shown in FIG. 4 is a double-cladding fiber 35, comprising a core 30, an internal cladding 31 and an external cladding 32. The core 30 shown here is in the form of a multi-mode core and has a diameter of 62.5 μm, while the diameter of the internal cladding is 200 μm. The core 30 serves for the guidance of the light to the free end of the double-cladding fiber 35 and thus to the Al glass mirror 14. The core 30 comprises, once again near the end of the double-cladding fiber 35, the Bragg grating 105.

The core 30 may have a low numerical aperture and therefore a low emission angle 33. The numerical aperture is here, for example, 0.1. The internal cladding 31 has a greater numerical aperture and therefore has a greater acceptance angle 34 at which light can be coupled in. For example, the numerical aperture is here 0.3. FIG. 3 does not represent the true emission angle or acceptance angle. In the internal cladding, the light beam reflected by the Al glass mirror 14 is coupled in again and guided back to the detector.

In some embodiments, the double-cladding fiber 35 means that the angle 18 at which the Al glass mirror 14 is tilted relative to the perpendicular arrangement can be increased. Rather than an angle of, for example, 11°, an angle of 12° or more, in particular 15°, can now be selected. The light output lost is here not as great as it would be if a simple optical fiber such as the glass fiber 11 were used and is weighed against and superseded by the gain in terms of signal resolution due to the increased angle and the associated increased signal strength in the case of deflection of the double-cladding fiber 35.

At the same time, reading of the temperature of the double-cladding fiber 35 by way of the Bragg grating 105 permits a further increase of the accuracy of the measured acceleration value.

A further configuration for the optical fiber is illustrated in FIG. 5 in a cross section that is not to scale. The multicore fiber 50 is likewise a double-cladding fiber having an external cladding 51 and an internal cladding 52. However, the internal cladding 52 now encloses a single-mode core 53 and three multi-mode cores 54, which are arranged one next to the other.

The Bragg grating 105 is arranged in the single-mode core 53. In the single-mode core 53, the reflection wavelength of the Bragg grating 105 may be easier to query than in a multi-mode core. The multi-mode cores 54 serve for guiding the radiation for the measurement of the acceleration, i.e. in the direction of the Al glass mirror 14. By using three multi-mode cores 54, good illumination in the internal cladding 52 after reflection of the radiation by the Al glass mirror 14 is achieved and as much radiation as possible is transported for a high signal quality.

In some embodiments, an individual multi-mode core 54 can also be used, which may be arranged centrally in the internal cladding 52 and thus ensures symmetrical illumination in the internal cladding 52, while the single-mode core 53 is arranged decentrally.

What is claimed is:

1. A fiber-optic accelerometer comprising:
an optical fiber having a free end, wherein the free end can be caused to vibrate under the influence of acceleration;
a light source for emitting visible, ultraviolet, or infrared light into the optical fiber at an end of the fiber opposite from the free end;
a mirror arranged to reflect a portion of the light exiting the free end back into the optical fiber; and
a detection device sensing reflected light at the end of the fiber opposite from the free end;
wherein a core of the optical fiber contains a Bragg grating in the free end.

2. The fiber-optic accelerometer as claimed in claim 1, wherein the detection device evaluates a reflection signal of the Bragg grating.

3. The fiber-optic accelerometer as claimed in claim 1, wherein the optical fiber comprises a single-mode waveguide.

4. The fiber-optic accelerometer as claimed in claim 1, wherein the optical fiber comprises a double-cladding fiber having a core, an internal cladding, and an external cladding.

5. The fiber-optic accelerometer as claimed in claim 4, wherein a numerical aperture of the core ranges from 0.075 to 0.14, and a numerical aperture of the internal cladding ranges from 0.22 to 0.5.

6. The fiber-optic accelerometer as claimed in claim 1, further comprising:
a single-mode core in which the Bragg grating is arranged; and
a multi-mode core.

7. The fiber-optic accelerometer as claimed in claim 1, wherein a length of the free end is between 12 and 18 mm.

8. The fiber-optic accelerometer as claimed in claim 1, wherein the termination surface of the free end comprises a fraction of the optical fiber at an angle of between 5° and 18°, with respect to a plane perpendicular to the fiber axis.

9. The fiber-optic accelerometer as claimed in claim 1, wherein tilting axes of the fracture of the optical fiber and of the mirror with respect to the plane perpendicular to the fiber axis are oriented to be parallel with respect to one another.

10. The fiber-optic accelerometer as claimed in claim 1, wherein a distance between a fiber termination surface and the mirror is between 25 μm and 75 μm.

11. The fiber-optic accelerometer as claimed in claim 1, wherein the weight oscillating the free end consists only of the weight of the optical fiber itself.

12. (canceled)
